(19) United States
(12) Patent Application Publication
(10) Pub. No.: US 2010/0172517 A1
(43) Pub. Date: Jul. 8, 2010

(54) Microphone Preamplifier Circuit and Voice Sensing Devices

(75) Inventors: Li-Te Wu, Taipei (TW); Jui-Te Chiu, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FORTEMEDIA, INC., Cupertino, CA (US)

(21) Appl. No.: 12/350,388

(22) Filed: Jan. 8, 2009

(51) Int. Cl. H04R 3/00; G10L 15/00

(52) U.S. Cl. 381/122; 704/246; 704/E15.001

(57) ABSTRACT

A microphone preamplifier circuit is provided. An amplifier comprises a first input end, a second input end, and an output end. A bias voltage is provided by a bias voltage source. A first sensor is coupled to the first input end and the bias voltage source for sensing a first physical parameter and a second physical parameter. A second sensor is coupled to the second input end and the bias voltage source for sensing the first physical parameter, wherein the second sensor is insensitive to the second physical parameter. The output end of the amplifier outputs a difference of the first and second input ends whereby noises and interferences are reduced.

### BACKGROUND OF THE INVENTION

1. Field of the Invention

The invention relates to a microphone preamplifier, and in particular, to a circuit structure that eliminates interferences within the circuit.

2. Description of the Related Art

FIG. 1 shows a conventional microphone preamplifier circuit. An amplifier 150 has a first input end (+), a second input end (−) and an output end. A microphone cartridge 120 is coupled between a bias voltage source 110 and the first input end (+), wherein the first input end (+) is biased by a bias resistor 130 and a reference voltage source 140. The output end is connected to the second input end (−). The microphone cartridge 120 may be an electret condenser microphone (ECM) comprising a moving diaphragm and a fixed back-plate functioning as an equivalent capacitor. The microphone cartridge 120 may also be a Micro mechanical electrical system (MEMS) microphone.

As known, voice is a kind of air pressure variation, and the microphone cartridge 120 can sense the air pressure variation to induce a charge variation. Thereby, voice signals are transposed into voltage signals. The amplifier 150 serves as a buffer to output a sensed voltage signal. Conventionally, the bias voltage source 110 exhibits significant noise, and the microphone cartridge 120 is sensitive to radio frequency interferences. Thus, quality of microphone preamplifiers is hindered due to the circuit structure.

### BRIEF SUMMARY OF THE INVENTION

An exemplary embodiment of a microphone preamplifier circuit is provided. An amplifier comprises a first input end, a second input end, and an output end. A bias voltage is provided by a bias voltage source. A first sensor is coupled to the first input end and the bias voltage source for sensing a first physical parameter and a second physical parameter. A second sensor is coupled to the second input end and the bias voltage source for sensing the first physical parameter, wherein the second sensor is insensitive to the second physical parameter. The output end of the amplifier outputs a difference of the first and second input ends.

The first sensor may be a microphone cartridge, and the second physical parameter is air pressure variation. The second sensor is a capacitor, and the first physical parameter is radio frequency (RF) interference, noise introduced by the bias voltage source, or both. The microphone cartridge is a MicroElectrical-Mechanical System (MEMS) microphone, or an Electret condenser microphone (ECM).

The microphone preamplifier may further comprises a reference voltage source, a first bias resistor coupled to the first input end and the reference voltage source, and a second bias resistor coupled to the second input end and the reference voltage source.

An exemplary embodiment of a voice sensing device is provided, comprising a circuit board and an integrated chip. The integrated chip is deployed on the circuit board, comprising an amplifier, a second sensor, and a first pad. A bias voltage source is deployed on the circuit board for providing a bias voltage. A first sensor is deployed on the circuit board, coupled to the first pad and the bias voltage source, for sensing the first physical parameter and a second physical parameter. The output end of the amplifier outputs a difference of the first and second input ends whereby interferences and noises are reduced.

A further embodiment of a voice sensing device is provided. The integrated chip comprises an amplifier, a first pad, and a second pad. The bias voltage source is deployed on the circuit board for providing a bias voltage. The first sensor is deployed on the circuit board, coupled to the first pad and the bias voltage source, for sensing a first physical parameter and a second physical parameter. The second sensor is deployed on the circuit board, coupled to the second pad, for sensing the first physical parameter, wherein the second sensor is insensitive to the second physical parameter. A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows a conventional microphone preamplifier circuit;

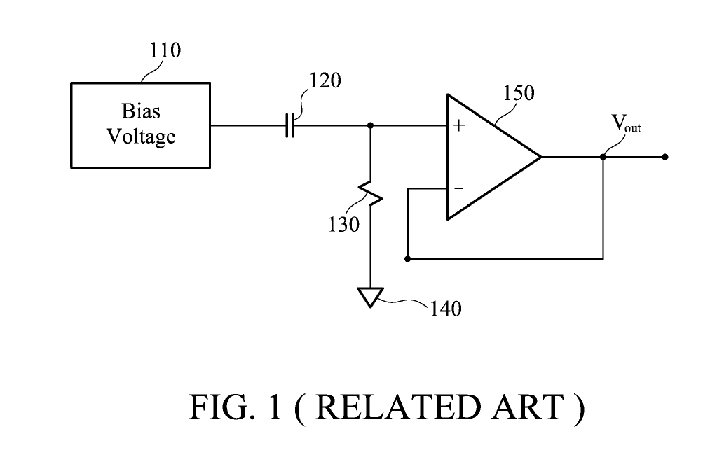

FIG. 2 shows an embodiment of a microphone preamplifier circuit according to the invention;

FIG. 3 shows an embodiment of a voice sensing device according to the invention; and

FIG. 4 shows another embodiment of a voice sensing device according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

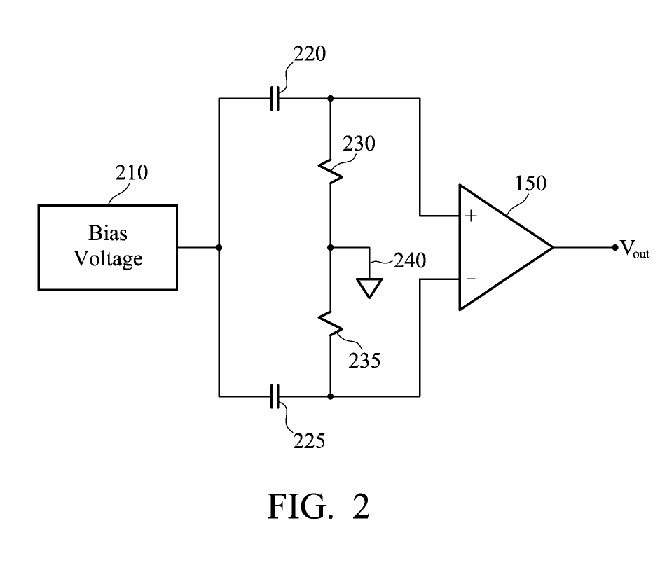

FIG. 2 shows an embodiment of a microphone preamplifier circuit according to the invention. A differential input structure is implemented. In the microphone preamplifier circuit, an amplifier 150 comprises a first input end (+), a second input end (−), and an output end. A bias voltage source 210 is provided to generate a bias voltage. A first sensor 220 is coupled to the first input end (+) and the bias voltage source 210, for sensing a first physical parameter and a second physical parameter. The first sensor 220 is a microphone cartridge, and the second physical parameter is air pressure variation. In the embodiment, the first physical parameter may be radio frequency (RF) interference, noise introduced by the bias voltage source, or both.

A second sensor 225 is coupled to the second input end (−) and the bias voltage source 210, for sensing the first physical parameter, wherein the second sensor 225 is insensitive to the second physical parameter. The second sensor 225 is a capacitor serving as a dummy microphone. The output end of the amplifier 150 outputs a difference of the first and second input ends.

The bias voltage provided by the bias voltage source 210 is modeled as:

V₂₁₀=V_{b}+Vₙ (1),

where V_{b} is the DC voltage of the bias voltage source 210, and Vₙ is the inherent noise voltage accompanied with the bias voltage. For MEMS microphones, the bias voltage source 210 is typically a charge pump providing a DC voltage V_{b} of 12V.

In the preamplifier circuit of FIG. 2, a reference voltage source 240 is provided. A first bias resistor 230 is coupled to the first input end (+) and the reference voltage source 240. A second bias resistor 235 coupled to the second input end (−) and the reference voltage source 240.

The voltage sensed by the first sensor 220 is modeled as:

V₂₂₀=Vᵣ+V_{b}(x/d)+Vₙ+V_{RF} (2),

where d is the distance between the diaphragm and the back plate, and x is the movement of the diaphragm under air pressure. V_{RF} is the radio frequency interference voltage induced on the first sensor 220. Vᵣ is the reference voltage provided by the reference source 240.

Meanwhile, the voltage sensed by the second sensor 225 is modeled as:

V₂₂₅=Vᵣ+Vₙ+V_{RF} (3).

If the preamplifier 150 has a gain G, the output voltage Vₒᵤₜ on the output end of the preamplifier is:

Vₒᵤₜ=G(V₂₂₀−V₂₂₅)=GV_{b}(x/d) (4).

It is shown that the RF noise interferences and bias voltage noises are effectively eliminated from the output voltage Vₒᵤₜ.

In the embodiment, the microphone cartridge 220 may be a MicroElectrical-Mechanical System (MEMS) microphone, and consequently, the bias voltage source 210 can be a charge pump circuit to provide sufficient bias voltage for the MEMS microphone. Alternatively, the microphone cartridge 220 may also be an Electret condenser microphone (ECM), and there are various types of microphones adaptable in the embodiment, which is not limited in the invention.

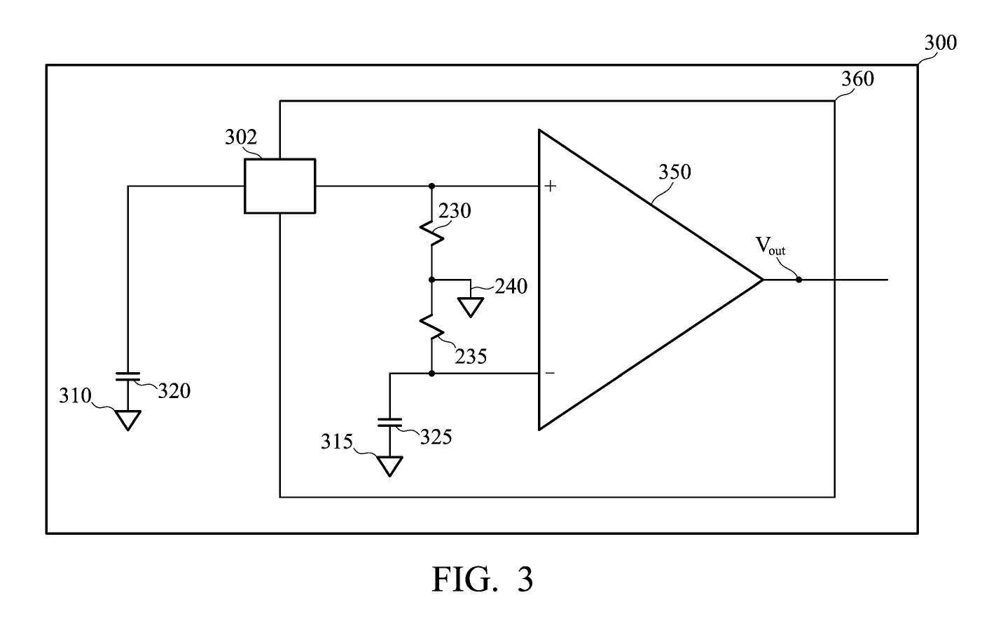

FIG. 3 shows an embodiment of a voice sensing device according to the invention. The differential circuit structure can be extended to eliminate different interference sources, for example, interferences within an integrated chip 360, or within the circuit board 300. The circuit board 300, such as a Print Circuit Board (PCB), can be a part of a voice sensing device, whereby an integrated chip 360 is deposited. The preamplifier circuit is implemented partially within the integrated chip 360 and partially on the circuit board 300. In this way, the second input end (−) of the amplifier 350 can collect difference interference sources to be eliminated.

In the integrated circuit 360, the amplifier 350 comprises a first input end (+) a second input end (−), and an output end. A second sensor 325 is implemented within the integrated circuit 360, coupled to the second input end (−) for sensing a first physical parameter. The integrated circuit 360 also comprises a first pad 302 coupled to the first input end (+), for receiving a signal from outside of the integrated circuit 360. In the embodiment, a first sensor 320 is implemented on the circuit board 300, coupled to the first pad 302. A bias voltage source 310 is also deployed on the circuit board 300 for providing a bias voltage. The first sensor 320 is a microphone cartridge for sensing the first physical parameter and the second physical parameter. In the embodiment, the first physical parameter can be radio frequency (RF) interferences induced inside of the integrated chip, noises introduced by the bias voltage source, or both. The second physical parameter is air pressure variation, which is also referred to as voices. The second sensor 325 is a capacitor, and the microphone cartridge may be a MicroElectrical-Mechanical System (MEMS) microphone or an Electret condenser microphone (ECM).

In the embodiment, the reference voltage source 240, first bias resister 230 and second bias resistor 235 are implemented inside of the integrated chip 360. The first bias resistor 230 is coupled to the first input end (+) and the reference voltage source 240. The second bias resistor 235 is coupled to the second input end (−) and the reference voltage source 240. The second sensor 325 may be coupled to a bias voltage source 315 within the integrated chip 360 which functions identically as the bias voltage source 310. Alternatively, the second sensor 325 may be coupled to the bias voltage source 310 through another wiring (not shown).

Since the first sensor 320 is deposited outside of the integrated chip 360 while the second sensor 325 is implemented inside of the integrated chip, they may sense different noise sources. Nevertheless, some interference can still be eliminated in this circuit structure.

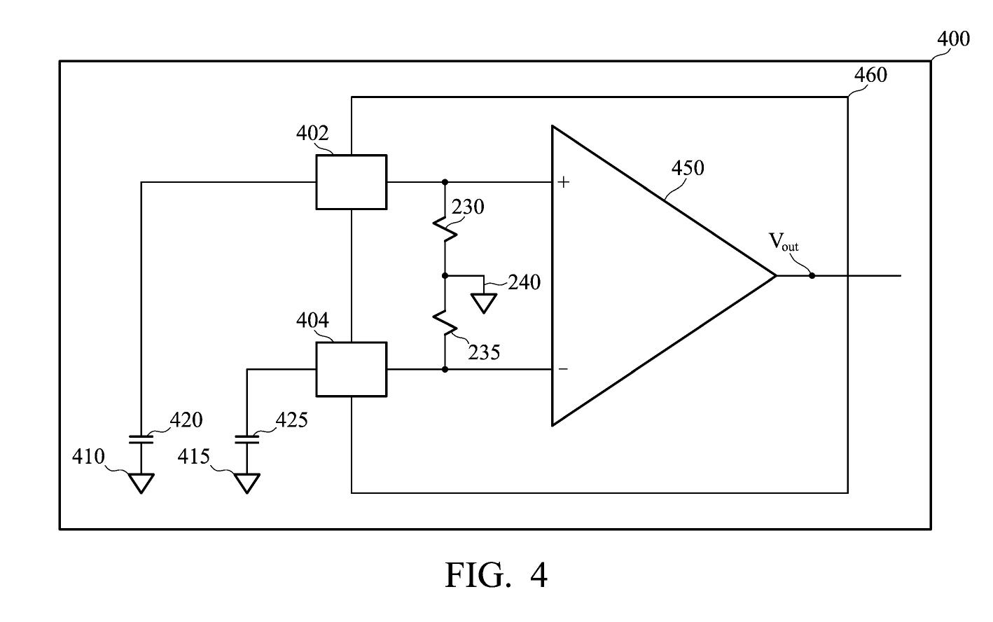

FIG. 4 shows another embodiment of a voice sensing device according to the invention. In the circuit board 400, an integrated chip 460 with two pads is implemented. The preamplifier circuit is also implemented partially within the integrated chip 460 and partially on the circuit board 400. In the integrated circuit 460, the amplifier 450 comprises a first input end (+), a second input end (−), and an output end. The integrated circuit 460 comprises a first pad 402 coupled to the first input end (+), and a second pad 404 coupled to the second input end (−).

A first sensor 420 is implemented on the circuit board 400, coupled to the first pad 402 for sensing a first physical parameter and a second physical parameter. Likewise, a second sensor 425 is implemented on the circuit board 400, coupled to the second pad 404 for sensing a first physical parameter. A bias voltage source 410 is also deployed on the circuit board 400 for providing a bias voltage. The first sensor 420 is a microphone cartridge for sensing the first physical parameter and the second physical parameter. As described, the first physical parameter can be radio frequency (RF) interferences induced inside of the integrated chip, noises introduced by the bias voltage source, or both. The second physical parameter is air pressure variation, which is also referred to as voices. The second sensor 425 is a capacitor, and the microphone cartridge may be a MicroElectrical-Mechanical System (MEMS) microphone or an Electret condenser microphone (ECM).

In the embodiment, the reference voltage source 240, first bias resister 230 and second bias resistor 235 are implemented inside of the integrated chip 460. The first bias resistor 230 is coupled to the first input end (+) and the reference voltage source 240. The second bias resistor 235 is coupled to the second input end (−) and the reference voltage source 240.

Since both the first sensor 420 and second sensor 425 are deposited outside of the integrated chip 460, the noises and interferences can be effectively eliminated as described in equations (1)-(4). The second sensor 425 may be coupled to a bias voltage source 415 which functions identically as the bias voltage source 410. Alternatively, the first and second sensors 420 and 425 may share the same bias voltage source 410 as shown in FIG. 2.

The microphone preamplifier circuit is implemented partially on the circuit board and inside an integrated chip. The circuit board is adaptable to be implemented a voice sensing device such as a digital recorder, a mobile phone or a camera. Thus, voice quality can be effectively improved with the proposed circuit structure.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A microphone preamplifier circuit, comprising:
an amplifier, comprising a first input end, a second input end, and an output end;
a bias voltage source for providing a bias voltage;
a first sensor coupled to the first input end and the bias voltage source, for sensing a first physical parameter and a second physical parameter; and
a second sensor coupled to the second input end and the bias voltage source, for sensing the first physical parameter, wherein the second sensor is insensitive to the second physical parameter,
wherein the output end of the amplifier outputs a difference of the first and second input ends.

2. The microphone preamplifier as claimed in claim 1, wherein:
the first sensor is a microphone cartridge; and
the second physical parameter is air pressure variation;

3. The microphone preamplifier as claimed in claim 2, wherein:
the second sensor is a capacitor; and
the first physical parameter is radio frequency (RF) interference.

4. The microphone preamplifier as claimed in claim 2, wherein:
the second sensor is a capacitor; and
the first physical parameter is noise introduced by the bias voltage source.

5. The microphone preamplifier as claimed in claim 2, wherein:
the microphone cartridge is a MicroElectrical-Mechanical System (MEMS) microphone; and
the bias voltage source is a charge pump circuit.

6. The microphone preamplifier as claimed in claim 2, wherein the microphone cartridge is an Electret condenser microphone (ECM).

7. The microphone preamplifier as claimed in claim 2, further comprising:
a reference voltage source;
a first bias resistor coupled to the first input end and the reference voltage source; and
a second bias resistor coupled to the second input end and the reference voltage source.

8. A voice sensing device, comprising:
a circuit board;
an integrated chip deployed on the circuit board, comprising:
an amplifier, comprising a first input end, a second input end, and an output end;
a second sensor, coupled to the second input end, for sensing a first physical parameter; and
a first pad, coupled to the first input end;
a bias voltage source, deployed on the circuit board for providing a bias voltage;
a first sensor, deployed on the circuit board, coupled to the first pad and the bias voltage source, for sensing the first physical parameter and a second physical parameter, and
wherein the output end of the amplifier outputs a difference of the first and second input ends.

9. The voice sensing device as claimed in claim 8, wherein:
the first sensor is a microphone cartridge; and
the second physical parameter is air pressure variation;

10. The voice sensing device as claimed in claim 9, wherein:
the second sensor is a capacitor; and
the first physical parameter is radio frequency (RF) interference induced inside of the integrated chip.

11. The voice sensing device as claimed in claim 9, wherein:
the second sensor is a capacitor; and
the first physical parameter is noise introduced by the bias voltage source.

12. The voice sensing device as claimed in claim 9, wherein:
the microphone cartridge is a MicroElectrical-Mechanical System (MEMS) microphone; and
the bias voltage source is a charge pump circuit.

13. The voice sensing device as claimed in claim 9, wherein the microphone cartridge is an Electret condenser microphone (ECM).

14. The voice sensing device as claimed in claim 2, wherein the integrated chip further comprises:
a reference voltage source;
a first bias resistor coupled to the first input end and the reference voltage source; and
a second bias resistor coupled to the second input end and the reference voltage source.

15. A voice sensing device, comprising:
a circuit board;
an integrated chip deployed on the circuit board, comprising:
an amplifier, comprising a first input end, a second input end, and an output end;
a first pad, coupled to the first input end; and
a second pad, couple to the second input end;
a bias voltage source, deployed on the circuit board for providing a bias voltage;
a first sensor, deployed on the circuit board, coupled to the first pad and the bias voltage source, for sensing a first physical parameter and a second physical parameter; and
a second sensor, deployed on the circuit board, coupled to the second pad, for sensing the first physical parameter, wherein the second sensor is insensitive to the second physical parameter, and the output end of the amplifier outputs a difference of the first and second input ends.

16. The voice sensing device as claimed in claim 15, wherein:
the first sensor is a microphone cartridge; and
the second physical parameter is air pressure variation;

17. The voice sensing device as claimed in claim 16, wherein:
the second sensor is a capacitor; and
the first physical parameter is radio frequency (RF) interference induced inside of the integrated chip.

18. The voice sensing device as claimed in claim 16, wherein:
the second sensor is a capacitor; and
the first physical parameter is noise introduced by the bias voltage source.

19. The voice sensing device as claimed in claim 16, wherein:
the microphone cartridge is a MicroElectrical-Mechanical System (MEMS) microphone; and
the bias voltage source is a charge pump circuit.

20. The voice sensing device as claimed in claim 16, wherein the microphone cartridge is an Electret condenser microphone (ECM).

21. The voice sensing device as claimed in claim 16, wherein the integrated chip further comprises:
a reference voltage source;
a first bias resistor coupled to the first input end and the reference voltage source; and
a second bias resistor coupled to the second input end and the reference voltage source.
